(19) United States
(12) Patent Application Publication
(10) Pub. No.: US 2010/0165379 A1
(43) Pub. Date: Jul. 1, 2010

(54) System For And Method Of Transmitting Device Status Information Via Syndication Services

(76) Inventors: Erik Nils Ackerman, Lexington, KY (US); David Zachery Lindsey, JR., Paris, KY (US); Samuel Leo Rhodus, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/346,238

(22) Filed: Dec. 30, 2008

(51) Int. Cl. G06F 3/12; G06F 17/30

(52) U.S. Cl. 358/1.15

(57) ABSTRACT

The present invention relates to a method of transmitting device status information via syndication services. Specifically, it relates to transmitting device status information of a printer, scanner, fax, multifunction printing device, or other printing device via syndication services such as RSS, Atom, or other syndication service to a user computer device. The device status information may be received via any syndication service reader or custom configurable client application.

### FIELD OF THE INVENTION

The present invention relates to a system for and method of transmitting device status information via syndication services. Specifically, it relates to transmitting device status information of a printer, scanner, fax, multifunction printing device, or other printing device via syndication services such as RSS, Atom, or other syndication service to a user computer device. The device status information may be received via any syndication service reader or custom configurable client application.

### BACKGROUND OF THE INVENTION

The setting of the present invention is a network (wired, wireless, or both) of devices such as printers, scanners, fax machines, multifunction printing devices, user computer devices, and handheld user computer devices. User computer devices connected to a network often need the ability to inform clients of device status information such as current status and status changes such as paper levels, ink or toner levels, or other alert conditions.

Device status information is a crucial component of any Information Technology organization. Traditionally, device status information updates are performed using a proprietary or standard networking protocol such as the Simple Network Management Protocol (SNMP) or the Network Printer Alliance Protocol (NPAP). When using these protocols, a proprietary software application for viewing the device status information is desired.

### SUMMARY OF THE INVENTION

The present invention addresses the need for a more standardized method of transmitting device status information to various user computer devices. Therefore, the present invention allows for device status information to be collected and viewed via known syndication services.

It is a first aspect of the present invention to provide a computer implemented method of transmitting device status information that includes: (a) linking a printing device via a data link to a syndication service server, the printing device having access to device status information pertaining to the printing device; (b) receiving the device status information from the printing device; (c) configuring the device status information such that the device status information is readable by the syndication service reader; and (d) transmitting the device status information to the syndication service reader. In another embodiment of this aspect, the syndication service server receives a query from the syndication service reader for device status information prior to transmitting the device status information to the syndication service reader.

In a more detailed embodiment of the first aspect, configuring the device status information occurs prior to the transmitting the device status information to the syndication service. In another detailed embodiment of the first aspect, configuring the device status information includes translating device status information into a format readable by the syndication service reader.

In another more detailed embodiment of the first aspect, the syndication service server is a computer-readable firmware application operating on the printing device. Further, configuring the device status information may include configuring the device status information into a standard syndication service format such as the Atom format, the Really Simple Syndication format, the Rich Site Summary format, and/or the RDF Site Summary format. In one embodiment of the first aspect, the syndication service reader is an Atom reader, a Really Simple Syndication reader, a Rich Site Summary reader, and/or an RDF Site Summary reader. In other embodiments, the syndication service reader is a customizable reader capable of displaying at least a portion of the device status information.

In a yet another more detailed embodiment of the first aspect, the one or more data links linking the printing device to a syndication service server is a wireless data link. In another embodiment of the first aspect, the syndication server is linked to a user computer device having a user interface via a data link, wherein the device status information may be displayed on a user interface. In another detailed embodiment of the first aspect, the syndication service reader is a computer-readable software application operating on the user computer device. In other embodiments, the data link linking the user computer device to the syndication service server or the syndication service reader is a wireless data link. The device status information includes at least one of: offline status, online status, error status, paper levels, toner levels, paper jam, and alert conditions.

It is a second aspect of the present invention to provide a computer implemented method of transmitting device status information that includes: (a) linking at least one printing device linked via one or more data links to a syndication service server, the at least one printing device having access to device status information pertaining to the at least one printing device; (b) linking the syndication service server to at least one syndication service reader; (c) creating a syndication service feed for each of the at least one printing device, the syndication service feeds configured such that the device status information is readable by the at least one syndication service reader; and (d) receiving a subscription request from the at least one syndication service reader for one or more of the syndication service feeds; and (e) transmitting the device status information to the at least one syndication service reader subscribing to the one or more syndication service feeds. The syndication service server may also transmit the device status information to the at least one the syndication service reader upon a specified time interval or when a change in device status information occurs. In another embodiment of this aspect, the syndication service server may query the at least one printing device for the device status information of the at least one printing device prior to creating a syndication service feed.

In another embodiment of this aspect, the syndication service server compiles the device status pertaining to each of the at least one printing device, creates a compiled syndication feed for the compiled device status information, receives a subscription request from the at least one syndication service reader for the compiled syndication service feed, and transmits the compiled device status information to the at least one syndication service reader subscribing to the compiled syndication service feed. In another detailed embodiment of the second aspect, the syndication service server may be linked to a computer device having a user interface via a data link, wherein the compiled device status information may be displayed on the user interface.

It is a third aspect of the present invention to provide a system for displaying printing device status information that includes (a) a printing device having access to device status information pertaining to the printing device; (b) a syndication service reader for displaying the device status information; and (c) syndication service server linked to the printing device via a data link, the syndication server being capable of configuring the device status information into a format readable by the syndication service reader. In another embodiment of this aspect, the syndication service reader is a component of a user computer device.

From the foregoing disclosure and the following detailed description of various preferred embodiments it will be apparent to those skilled in the art that the present invention provides a significant advance in the art of methods of transmitting device status information via syndication services. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a flow diagram of one embodiment of the present invention.

FIG. 2 is a view of an exemplary hardware and software environment utilized in one embodiment of the present invention.

FIG. 3 is a view of an exemplary hardware and software environment utilized in one embodiment of the present invention.

FIG. 4 is a view of an exemplary hardware and software environment utilized in one embodiment of the present invention.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “linked” and variations thereof are used herein broadly and encompass direct and indirect connections, couplings, and mountings. In addition, the terms “connected”, “coupled”, and “linked” and variations thereof are not restricted to physical or mechanical connections or couplings.

### DETAILED DESCRIPTION OF THE DRAWINGS

It will be apparent to those skilled in the art that many uses and variations are possible for the methods of transmitting device status via syndication services. The following detailed discussion of various alternative and preferred embodiments will illustrate the general principles of the present invention. Other embodiments will be apparent to those skilled in the art given the benefit of this disclosure.

The present invention generally relates to a method of transmitting device status information via syndication services from a printing device to a user computer device. Some examples of printing devices include printers, scanners, fax machines, multifunction printing devices, and other printing devices. Some examples of user computer devices include computer servers, personal computers, desktop computers, laptop computers, handheld computers, personal digital assistants, cellular telephones, and other user computer devices. Various embodiments may utilize a plurality of printing devices and/or a plurality of user computer devices.

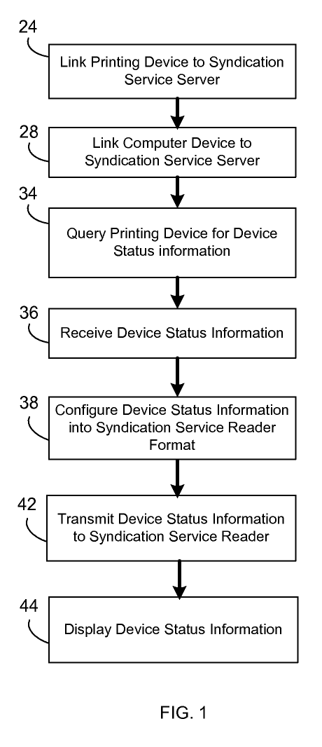

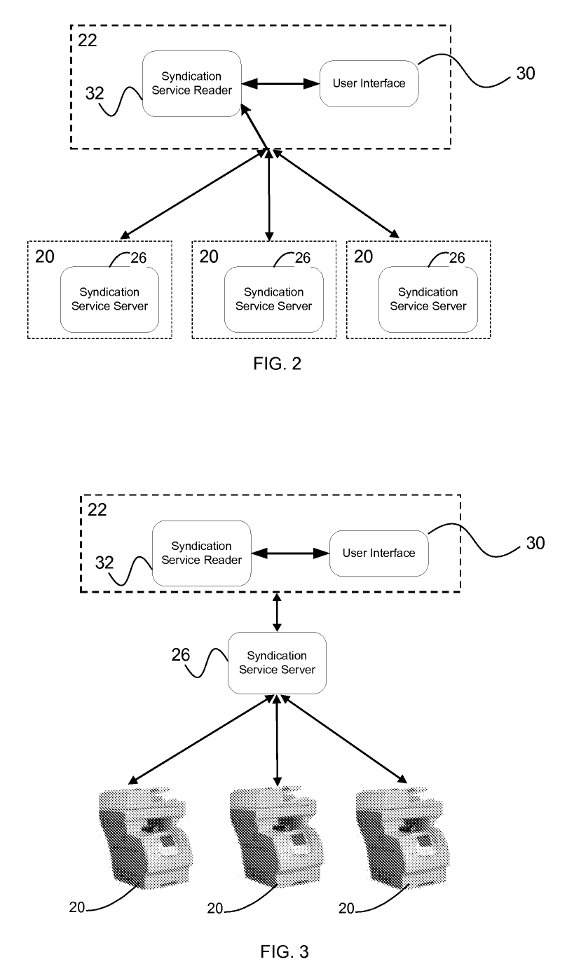

FIG. 1 depicts a flow diagram of one embodiment of the present invention, which may operate on a system as shown in FIG. 2. In this embodiment, a computer implemented method of transmitting device status information is provided. This method teaches linking at least one printing device 20 via one or more data links to a syndication service server 26 (block 24). The printing device 20 has access to device status information of the printing device 20. This method also teaches at block 28 linking a user computer device 22 having a user interface 30 and a syndication service reader 32 to the syndication service server 26 via one or more data links (block 28). At block 34, the syndication service server 26 queries the printing device 20 for the device status information. In response to this query, the printing device 20 transmits the device status information to the syndication service server 26 at block 36. The syndication service server 26 then configures the device status information into a format readable by the syndication service reader 32 (block 38). In exemplary embodiments of this aspect, this format may be the standard Atom format, the Really Simple Syndication format, the Rich Site Summary format, and/or the Resource Description Framework (RDF) Site Summary format. At block 42, the syndication service server 26 transmits the device status information to the syndication service reader 32. In other embodiments, the syndication service reader 32 queries the printing device 20 for the device status information prior to the transmission of the device status information to the syndication service reader 32. The device status information may then be displayed on the user interface 30 operating on the user computer device 22 at block 44.

Device status information may be any type of information indicating status of the printing device itself or a component thereof. Device status may include but is not limited to, offline status, online status, error status, number of pages printed, number of pages scanned, number of copies made (e.g., 1/20), ink or toner supply levels, paper levels, toner levels, intervention conditions, device warnings, paper jam, and other alert or status conditions.

Data links linking various components of the embodiments of the present invention may be any known data links. For example, the data link linking the printing device 20 to the syndication service server 26 may be wired or wireless. A wired data link may include integrated circuitry within the printing device 20, a USB data link, Firewire data link, or other similar data link. A wireless data link may include a Wi-Fi data link, WiMax data link, wireless USB data link, Bluetooth data link, or other similar data link. In another example, the data link linking the user computer device 22 to the syndication service server 26 may be a wireless data link while the data link linking the user computer device 22 to the syndication service reader 32 may be wired. In yet another example, the data link linking the user computer device 22 to the syndication service server 26 may be a wired data link while the data link linking the user computer device 22 to the syndication service reader 32 may be wireless.

The syndication service server 26 may be any server that provides access to files in a format readable by the syndication service reader 32. Examples of syndication service server 26 include a web server and an ftp server. The syndication service server 26 may be incorporated within the printing device 20 natively or as an add-on feature by a software application, firmware integration and/or hardware implementation. In other embodiments, the syndication service server 26 may be located external to the printing device 20 as shown in FIG. 3 as hardware, software or a combination thereof. It is also possible that the syndication service server 26 is located on the user computer device 22.

Primary functions of the syndication service server 26 include querying printing devices 20 for device status information, receiving device status information, and transmitting device status information. In an exemplary embodiment, the syndication service server 26 configures or formats the received device status information into a format readable by the syndication service reader 32. Such configuration or formatting may include translating the device status information.

In an exemplary embodiment, the configuring or formatting the device status information includes configuring the device status information into a standard syndication service format such as the Atom format, the Really Simple Syndication format, the Rich Site Summary format, and/or the RDF Site Summary format. However, any standard syndication service format may be utilized in the present invention so long as the format is readable by the syndication service reader 32.

The syndication service reader 32 may be a software application operating on the user computer device 22, a software application extension, a web portal service, or other web-based utility. The syndication service reader 32 may be a standard syndication service reader or a customized client reader. Examples of known software application syndication service readers 32 include, without limitation, FeedDemon, RSS Bandit, and KlipFolio. Web-based syndication service readers 32 include, without limitation, NewsGator, Google Reader, and BlogLines. Additionally, the syndication service reader 32 may be implemented to display the device status information in web-based portals, internet browser applications, electronic mail applications, or blog editors. In an exemplary embodiment, the syndication service reader 32 is an Atom reader, a Really Simple Syndication reader, a Rich Site Summary reader, or an RDF Site Summary reader.

A user may configure what and how the device status information is transmitted to or displayed by the syndication service reader 32 through an interface on the printing device 20. The user may also make the configurations through the interface of the user computer device 22, the syndication service reader 32, or the syndication service server 26.

The syndication service reader 32 may also be a customized client reader. In one embodiment, the syndication service reader 32 is a user- or administrator-configurable reader having the ability to customize the exact portion(s) and appearance of the device status information displayed to the user. This information may include all or a subset of the device status information.

In one embodiment, the syndication service reader 32 may be custom client application that includes a customizable user interface that allows a user to select which device to subscribe to, what device status information to display, and/or what devices to combine into a single feed. This customized syndication service reader 32 may be developed and/or administered by a user, a system administrator, a retail seller, or a device manufacturer.

In some embodiments, the syndication service reader 32 may be an internal component of the user computer device 22. In yet other embodiments, the syndication service reader may a device external to the user computer device 22.

In some embodiments, each printing device 20 has the means of accessing and transmitting device status information of the printing device 20 directly to the syndication service reader 32 via the user computer device 22. In these embodiments, external syndication service servers 26 may not be necessary. The capability of a printing device 20 to access and transmit device status information may be a native capability of the printing device's 20 firmware. This capability may also be an add-on feature through use of a software application, hardware component or combination thereof.

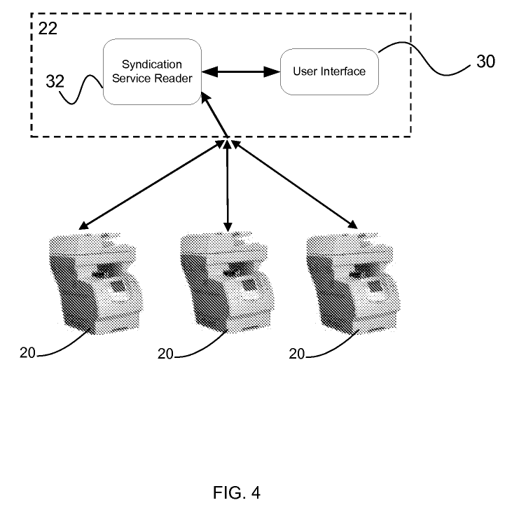

FIGS. 2, 3, and 4 depict views of exemplary hardware and software environments utilized in various embodiments of the present invention. FIG. 2 shows an environment in which the syndication service server 26 is incorporated into the printing device 20. FIG. 3 shows an environment in which there is a single syndication service server 26 that is not incorporated into a printing device 20. FIG. 4 shows an environment in which the printing devices 20 communicate directly with the user computer device 22. All three of these environments may be utilized in various embodiments of the present invention.

The environment shown in FIG. 2 includes a user computer device 22 and a plurality of printing devices 20. The user computer device 22 includes a user interface 30 and a syndication service reader 32 operating as a software application thereon. The printing devices 20 include hardware for printing as well as a syndication service server 26 operating as a firmware or software application. In this embodiment, each printing device 20 has its own syndication service server 26. Each syndication service server 26 communicates with the syndication service reader 32 via the user computer device 22. In this embodiment, querying and transmitting occurs between each of the syndication service servers 26 and the syndication service reader 32 by way of the user computer device 22.

The environment shown in FIG. 3 includes a user computer device 22, a syndication service server 26, and a plurality of printing devices 20. The user computer device 22 also includes a user interface 30 and a syndication service reader 32 operating as a software application thereon. Each printing device 20 in this environment does not have its own individual syndication service server 26. This environment provides that all of the printing devices 20 communicate with a single syndication service server 26. Each printing device 20 has the means of accessing and transmitting device status information of the printing device 20 to the syndication service server 26. The syndication service server 26 communicates device status information from any or all of the printing devices 20 to the syndication service reader 32 via the user computer device 22. Therefore, querying and transmitting occurs between the single syndication service server 26 and the syndication service reader 32 by way of the user computer device 22.

In the environment of FIG. 3, syndication service server 26 may be capable of creating individual syndication feeds for the device status information of each of the printing devices 20. Syndication service server 26 may also be capable of creating a single syndication feed into which the device status information of each of the printing devices 20 is compiled.

The environment shown in FIG. 4 includes a user computer device 22 and a plurality of printing devices 20. The user computer device 22 also includes a user interface 30 and a syndication service reader 32 operating as a software application thereon. Each printing device 20 has the means of accessing and transmitting device status information of the printing device 20 directly to syndication service reader 32 via the user computer device 22. In this environment, the syndication service server (not shown) is firmware native to the printing device 20. Therefore, querying and transmitting occurs between each printing device 20 and the syndication service reader 32 by way of the user computer device 22.

While the above embodiments tend to focus on printing environments, other embodiments of the present invention may be implemented outside the scope of a printing environment. Other embodiments of the invention may include other devices and networks such as security systems and data collection. One such example may be a network appliance that alerts a client when an intrusion detection flag is triggered. Another example may be a computer server that collects statistical information from networked devices and sends a status message to another device.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A computer implemented method of transmitting device status information, comprising:
linking a printing device via a data link to a syndication service server, the printing device having access to device status information pertaining to the printing device;
receiving the device status information from the printing device;
configuring the device status information such that the device status information is readable by a syndication service reader;
transmitting the device status information to the syndication service reader for display.

2. The computer implemented method of claim 1, further comprising:
receiving a query from the syndication service reader for device status information prior to the transmitting the device status information to the syndication service reader.

3. The computer implemented method of claim 1, wherein the configuring the device status information occurs prior to the transmitting the device status information to the syndication service reader.

4. The computer implemented method of claim 1, wherein the configuring the device status information includes translating device status information into a format readable by the syndication service reader.

5. The computer implemented method of claim 1, wherein the syndication service server is a computer-readable firmware application operating on the printing device.

6. The computer implemented method of claim 1, wherein the configuring the device status information includes configuring the device status information into a standard syndication service format.

7. The computer implemented method of claim 1, wherein the syndication service reader is one of an Atom reader, a Really Simple Syndication reader, a Rich Site Summary reader, and an RDF Site Summary reader.

8. The computer implemented method of claim 1, wherein the syndication service reader is a customizable reader capable of displaying at least a portion of the device status information.

9. The computer implemented method of claim 1, wherein the data link linking the printing device to the syndication service server is a wireless data link.

10. The computer implemented method of claim 1, further comprising:
linking a computer device having a user interface via a data link to the syndication service server and the syndication service reader, wherein the device status information may be displayed on the user interface.

11. The computer implemented method of claim 10, wherein the syndication service reader is a computer-readable software application operating on the user computer device.

12. The computer implemented method of claim 10, wherein the data link linking the user computer device to at least one of the syndication service server and the syndication service reader is a wireless data link.

13. The computer implemented method of claim 1, wherein the device status information includes at least one of: offline status, online status, error status, paper levels, toner levels, paper jam, and alert conditions.

14. A computer implemented method of transmitting device status information, comprising:
linking at least one printing device to a syndication service server, the at least one printing device having access to device status information pertaining to the at least one printing device;
linking the syndication server to at least one syndication service reader;
creating a syndication service feed for each of the at least one printing device, the syndication service feeds configured such that the device status information is readable by the at least one syndication service readers;
receiving a subscription request from the at least one syndication service reader for one or more of the syndication service feeds; and
transmitting the device status information to the at least one syndication service readers subscribing to the one or more syndication service feeds.

15. The computer implemented method of claim 14, wherein the transmitting occurs at one of a specified time interval and when a change in device status information occurs.

16. The computer implemented method of claim 14, further comprising:
querying the at least one printing device for the device status information of the at least one printing device prior to the creating a syndication service feed.

17. The computer implemented method of claim 14, further comprising:
compiling the device status information pertaining to each of the at least one printing device;
creating a compiled syndication service feed for the compiled device status information;
receiving a subscription request from the at least one syndication service reader for the compiled syndication service feed; and
transmitting the compiled device status information to the at least one syndication service reader subscribing to the compiled syndication service feed.

18. The computer implemented method of claim 17, further comprising:
linking a computer device having a user interface via a data link to the syndication service server, wherein the compiled device status information may be displayed on the user interface.

19. A system for displaying printing device status information, comprising:
a printing device having access to device status information pertaining to the printing device;
a syndication service reader for displaying the device status information; and
a syndication service server linked to the printing device, the syndication service server being capable of configuring the device status into a format readable by a syndication service reader.

20. The system of claim 19, wherein the syndication service reader is a component of a user computer device.
